(19) United States
(12) Patent Application Publication
(10) Pub. No.: US 2025/0029359 A1
(43) Pub. Date: Jan. 23, 2025

(54) METHOD AND SYSTEM FOR MULTIFUNCTIONAL IMAGE PREPROCESSING AND ANALYSIS OF ORGANOIDS

(71) Applicant: UNIVERSITY OF NORTH TEXAS, Dallas, TX (US)

(72) Inventors: Huaxiao YANG, Dallas, TX (US); Jathin Pranav SINGARAJU, Dallas, TX (US); Adheesh KADIRESAN, Dallas, TX (US)

(21) Appl. No.: 18/778,412

(22) Filed: Jul. 19, 2024

Related U.S. Application Data
(60) Provisional application No. 63/514,786, filed on Jul. 20, 2023.

(51) Int. Cl. G06V 10/74; G06T 5/70; G06T 5/90; G06T 7/00; G06T 7/62; G06V 10/40; G06V 20/69

(52) U.S. Cl. CPC G06V 10/74; G06T 5/70; G06T 5/90; G06T 7/0012; G06T 7/62; G06V 10/40; G06V 20/695; G06T 2207/10056

(57) ABSTRACT

A method for analyzing a plurality of organoids includes obtaining a plurality of images for an organoid of the plurality of organoids, and determining a plurality of features from the plurality of images, determine, using the plurality of features for the plurality of images, one or more differentiation factors between the plurality of images. The plurality of features comprise a plurality of an organoid area, a total image area, a percentage of the image covered by organoid, a total intensity of organoid, a total intensity of organoid-by-organoid area, or a total intensity of organoid by total image area. The one or more differentiation factors comprise small molecule factors and growth factors.

### CROSS-REFERENCE TO RELATED APPLICATIONS

This application claims priority to U.S. Provisional Application Ser. No. 63/514,786 filed Jul. 20, 2023 and entitled “Organalysis: A Graphical User Interface-Based Multifunctional Image Preprocessing and Analysis Software for Cardiac Organoid Studies,” which is incorporated herein by reference in its entirety.

### STATEMENT REGARDING FEDERALLY SPONSORED RESEARCH OR DEVELOPMENT

Not applicable.

### FIELD

The present disclosure relates generally to methods and systems for analysis of organoids. More particularly, the present disclosure relates to methods and systems for multifunctional image preprocessing and analysis of organoids, for example, cardiac organoids.

### BACKGROUND

With recent advancements in human pluripotent stem cell (hPSC)-derived organoids, various characterization techniques have been in considerable development for better studying and applying hPSC-derived organoids in disease modeling and regenerative medicine. One of the major characterization approaches for visualizing the hPSC-derived organoids is microscopic imaging. Correspondingly, image-processing techniques are needed for image preprocessing and image analysis.

In the area of organoid analysis, image preprocessing is the process of manipulating and enhancing microscopic images before they are analyzed, while image analysis is the process of extracting useful information from microscopic images for examination and comparison to determine scientific results and trends. Image processing of biological samples has become increasingly critical to further extracting extended information from hPSC-derived organoid studies. Currently, various approaches have been applied to analyze organoid formation and growth, track organoid circularity and area, and in-focus imaging. However, the results of these approaches often lack other key features of microscopic images, such as overall intensity, average intensity over the area, and fractal dimension of representing organoid structure. Moreover, these approaches are often subject to potential technical shortcomings in down-sampling for conserving memory, the lack of a simple graphical user interface (GUI), and difficulties in organoid shape fitting. Additionally, while the ImageJ software, available from the National Institutes of Health, supplies a wide array of image processing tools including fractal analysis (Fractals and Complexity, n.d.) brightness/contrast enhancements, and noise removal, it has a very convoluted interface, sometimes requiring repetitive clicks to automate a function, making ImageJ only suitable for small-scale, or image-by-image, processing methods, making batch processing with multiple images extremely time-consuming and inconsistent. ImageJ, therefore, is less automated and inefficient for large folders of images and is not usable when analyzing image results from high-throughput hPSC-derived organoid studies with multiple controlling factors and pathophysiological phenotypes in disease modeling and regeneration medicine.

As such, improvements methods and systems of image preprocessing and analysis are urgently needed for hPSC-derived organoid research.

### SUMMARY

In some embodiments, a system for analyzing a plurality of organoids comprises an imaging device configured to collect an image for an organoid of the plurality of organoid, and a non-transitory medium comprising instructions causing a computer to implement an organoid analysis platform. The organoid analysis platform is configured to perform an organoid analysis method.

In some embodiments, a method for analyzing a plurality of organoids comprises obtaining an image for an organoid of the plurality of organoid, and performing, via an organoid analysis platform embodied in instructions stored on a non-transitory medium, an organoid analysis method.

These and other features will be more clearly understood from the following detailed description taken in conjunction with the accompanying drawings and claims.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a flowchart illustrating the operation of the disclosed Organalysis platform according to one or more embodiments herein;

FIG. 2 is a representation of a Graphical User Interface (GUI) 200 associated with the Organalysis platform according to one or more embodiments herein;

FIG. 3 is the results the brightness and contrast functions according to one or more embodiments herein;

FIG. 4 is the results the brightness and contrast functions according to one or more embodiments herein;

FIG. 5 is the results the brightness and contrast functions disclosed herein;

FIG. 6 is the corresponding organoid intensities per pixel of FIG. 3; and

FIG. 7 is the corresponding organoid intensities per pixel of FIG. 4;

FIG. 8 is the corresponding organoid intensities per pixel of FIG. 5;

FIG. 9 is an illustration of batch processing of images according to one or more embodiments herein;

FIG. 10 is an illustration of the results of noise removal according to one or more embodiments disclosed herein.

FIG. 11 is an illustration of the results of noise removal according to one or more embodiments disclosed herein.

FIG. 12 is an illustration of the results of noise removal according to one or more embodiments disclosed herein.

FIG. 13 is a graph illustrating the accuracy of the noise removal technique on CFP images with noise, as disclosed herein.

FIG. 14 is a graph illustrating accuracy of the noise removal technique on CFP images without noise, is disclosed herein.

FIG. 15 is an illustration of the results of the noise removal according to one or more embodiments disclosed herein.

FIG. 16 is an illustration of the of the area and intensity measurement functionality as disclosed herein.

FIG. 17 is an illustration of the of the area and intensity measurement functionality as

disclosed herein.

FIG. 18 is an illustration of the data output of the area and intensity measurement functionality is disclosed herein.

FIG. 19 is hPSC-derived cardiac organoids were also measured at 9 and 13 days as disclosed herein.

FIG. 20 includes graphs indicating the percentage errors of the measurements disclosed herein.

FIG. 21 is an illustration of one or more aspects of the fractal analysis of organoids as disclosed herein.

FIG. 22 is an illustration of one or more aspects of the fractal analysis of organoids as disclosed herein.

FIG. 23 is an illustration of one or more aspects of the fractal analysis of organoids as disclosed herein.

FIG. 24 is an illustration of one or more aspects of the fractal analysis of organoids as disclosed herein.

FIG. 25 is an illustration of one or more aspects of the fractal analysis of organoids as disclosed herein.

FIG. 26 is an illustration of one or more aspects of the fractal analysis of organoids as disclosed herein.

FIG. 27 is an illustration of one or more aspects of differentiation factors as disclosed herein.

FIG. 28 is an illustration of one or more aspects of differentiation factors as disclosed herein.

FIG. 29 is an illustration of one or more aspects of differentiation factors as disclosed herein.

FIG. 30 is an illustration of one or more aspects of differentiation factors as disclosed herein.

FIG. 31 is an illustration of one or more aspects of differentiation factors as disclosed herein.

FIG. 32 is an illustration of one or more aspects of differentiation factors as disclosed herein.

### DETAILED DESCRIPTION

The following discussion is directed to various exemplary embodiments. However, one skilled in the art will understand that the embodiments and examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates to the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct engagement between the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

Disclosed herein are methods and systems for multifunctional image preprocessing and analysis of organoids, for example, cardiac organoids. Generally, in some embodiments, the methods may be performed via a system comprising a multifunctional application, referred to as the “Organalysis” platform. The Organalysis platform is configured for batch preprocessing and analyzing fluorescent images from the hPSC-derived cardiac organoids. The Organalysis platform allows users to control all the processes at once with fewer clicks through a user-friendly GUI. Currently, there is no automated system that provides such functions and that is targeted at handling batch processing. In addition, the Organalysis platform may include a feature importance function, which may be important to understanding the effect of differentiation factors on the hPSC-derived cardiac organoid formation. As will be disclosed herein, the Organalysis platform may utilize new algorithms with more efficacy into a consolidated environment, enabling users to employ the Organalysis platform with ease and accuracy.

Generally, the Organalysis platform disclosed herein may generally include a processor and storage. The processor is generally an instruction execution device that executes instructions retrieved from the storage. A processor suitable for use as the processor may be a general-purpose microprocessor, digital signal processor, microcontroller, or other devices capable of executing instructions retrieved from a computer-readable storage medium. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. The storage may generally be a non-transitory computer-readable storage device suitable for storing instructions executable by the processor. The storage may include volatile storage such as random-access memory, non-volatile storage (e.g., a hard drive, an optical storage device (e.g., CD or DVD), FLASH storage, read-only-memory), or combinations thereof. The storage may contain software instructions that are executed by the processor and/or data that is manipulated by the processor. The processor may execute the instructions retrieved from the storage to provide control and data processing functionality to the Organalysis platform. In some embodiments, the storage may include an ultrasound control logic. For example, the processor may execute instructions of the ultrasound control logic to control the operation of the Organalysis platform.

Herein, the fluorescence images of hPSC-derived cardiac organoids with the same protocol are used to test and evaluate the Organalysis platform. The hPSC-derived cardiac organoids are made up of three main fluorescence-labeled cardiovascular cell types: smooth muscle cells, cardiomyocytes, and endothelial cells. The hPSC-derived cardiac organoids were live-cell imaged in blue (Cyan Fluorescent Protein, CFP), green (Green Fluorescent Protein, GFP), and red/orange (Monomeric Orange Protein, mOr), respectively.

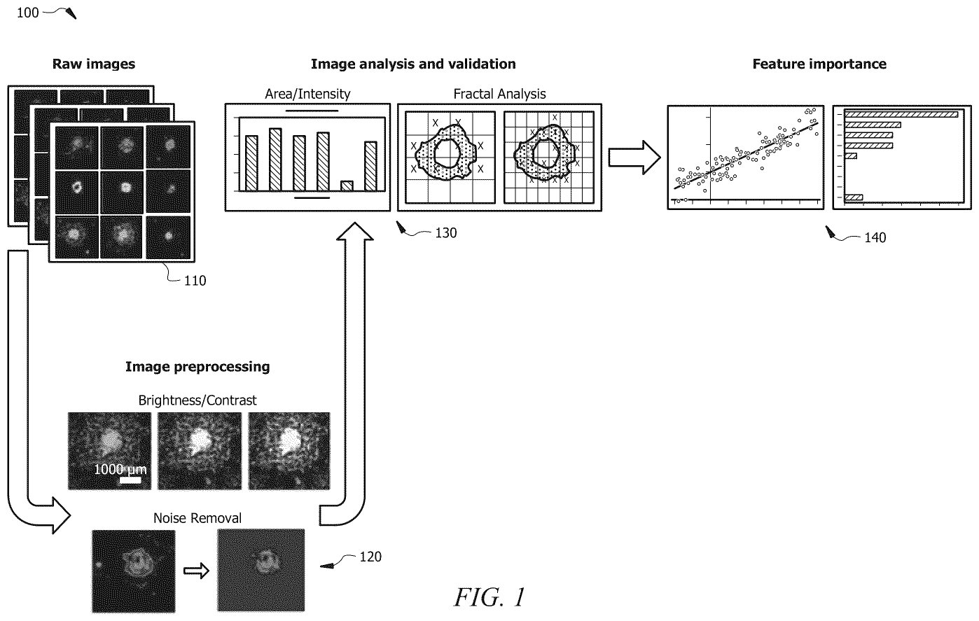

Referring to FIG. 1, a flowchart illustrating the operation of the disclosed Organalysis platform is shown. Generally, the embodiment of FIG. 1 depicts a method 100 that begins with inputting raw fluorescence microscopic images and further includes steps related to image preprocessing, analysis, and validation. For example, as shown in FIG. 1, the method 100 generally comprises the steps of obtaining raw images 110; preprocessing those images using the brightness and/or contrast adjustment and noise removal features 120; analyzing and validating those images via the area/intensity calculation algorithm and the fractal analysis function 130; and comparing the results with the feature importance function to understand the organoid intricacies 140.

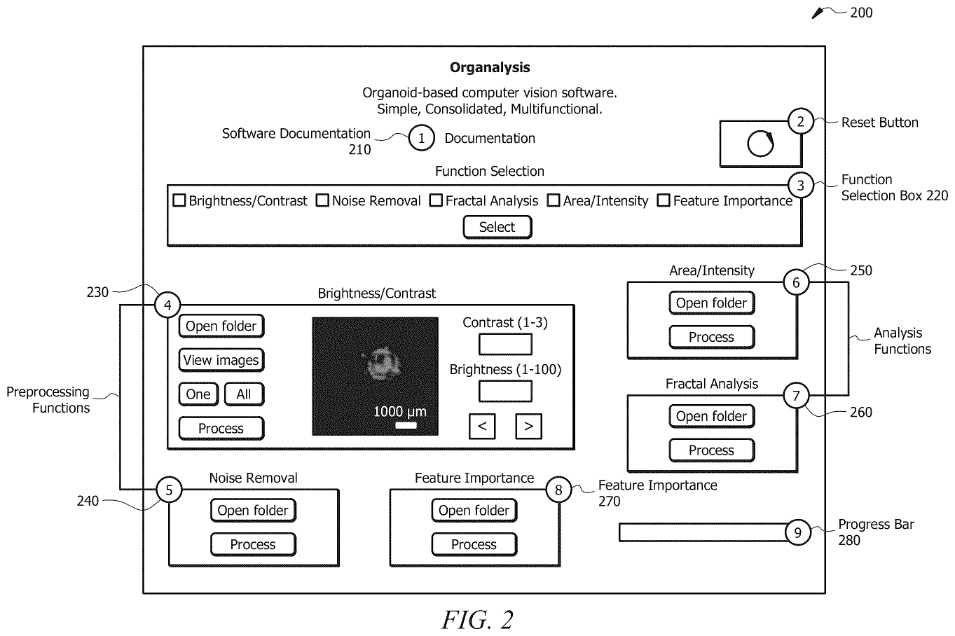

Referring to FIG. 2, a representation of a Graphical User Interface (GUI) 200 associated with the Organalysis platform. In the embodiment of FIG. 2, the GUI 200 associated with the Organalysis platform provides various functionalities. For example, the GUI 200 includes documentation software 210 hosted on a servers; a selection box to enable selection of a function to be performed 220; a brightness/contrast of image change function 230, which may be characterized as a first preprocessing function; a noise removal function 240 for a selected folder of images, which may be characterized as a second preprocessing function; a function to obtain area/intensity calculations 250 for a selected folder of images, which may be characterized as a first analysis function; a function to analyze the fractal dimensions 260 for a selected folder of images, which may be characterized as a second analysis function; a function to obtain the feature importance based on the organoid differentiation factors and/or cardiovascular cell types 270, which may be characterized as a first comparison function; and a progress bar 280.

As shown in the embodiment of FIG. 1, the Organalysis platform generally includes five functions in three categories: preprocessing, analysis, and comparison methods. For example, the functions comprising the preprocessing portions of the methods include brightness/contrast adjustments and noise removal. Also, for example, the functions comprising the analysis portions of the methods include area/intensity measurements and fractal analysis. Also, for example, the functions comprising the comparison portions of the method include the feature importance function for determining the various conditions seen in the images of organoids. Not intending the be bound by theory, employing the specific methodologies and/or algorithms disclosed here to determine information about the organoid, this Organalysis platform proved to be especially useful in rapid experimentation methods. In the study, the application processed the hPSC-derived cardiac organoid data (CFP, GFP, and mOr images) and generated an Excel report and/or a folder of updated images depending on the function.

Generally, as shown in FIG. 2, the Organalysis platform may provide a simple, user-friendly platform. For example, the design is intuitive, reducing the total number of clicks necessary to achieve various of the designated functions. Additionally, in some embodiments, the Organalysis platform may enable each function to be carried out with respect to multiple images at once, thereby streamlining the human-to-program interaction.

In some embodiments, the Organalysis platform may be built using a suitable programming language, for example, Python. The frontend of the Organalysis platform (e.g., user interface) and backend of the Organalysis platform (functional operations) may both be natively programmed through Python's Tkinter package, a Python extension to the Tk GUI framework. The GUI framework may then be downloaded as standalone software by Python's PyInstaller package.

In some embodiments, an image of an organoid may be provided. For example, in some embodiments, the image may be collected via a suitable imaging device such as a microscope comprising or associated with a camera. For example, the image may be a microscopic image. In some embodiments, the image may be a fluorescent image.

In some embodiments, the brightness and contrast enhancement feature used the convertScale Abs function commercially available from OpenCV (OpenCV: Operations on Arrays, n.d.) to supply an interface for adjusting the brightness and contrast of all images in one folder. The interface may allow the user to traverse a folder of images and adjust the brightness and contrast of each image. For instance, with the first click, the user may open the folder with a plurality of the fluorescently colored organoid images. With a second click, the user may place the images onto the screen, allowing the user to toggle between the images. When the user found a raw image, the brightness and contrast values were manipulated to better augment the features.

This function may utilize alpha, a multiplicative scale factor, and beta, an additive scale factor, parameters to manipulate the brightness and contrast of an image. The formula to update a pixel's value based on the alpha and beta parameters is given below:

$$Updated Pixel Value = Original Pixel Value \times ( alpha \pm beta )$$

For example, the user may enter in decimal-precise numbers for the contrast (alpha) value, which may range from 1.0 to 3.0, and the brightness (beta) value, which may range from a 0.0 to 100.0. With the third click, the user may visualize the changes made to the image and determine the best parameters to enter in the text fields. The user can either press ‘one’ to update just that image, or press ‘all’ to update every image in the folder. Finally, once the desired images were changed, the user may click ‘process’ to finish the function and download the folder of updated images.

In some embodiments, the noise removal function used OpenCV to remove unwanted artifacts and noise from a microscope image of an organoid. For example the function may be used to sharpen the image using the OpenCV package in Python. Additionally, the function may also use a threshold associated with the image to identify the morphology and amplify the features of the image. The function may identify any “blobs” in the image and may employ a contour detection algorithm available from OpenCV. Also, in some embodiments, if the specified pixels in the image were within the identified contour, the function may retain their values. Also, if the specified pixels in the image were not within the identified contour, the function may turn their color to black (zero intensity). This technique may be effective to turn any pixels contributing to noise into black pixels so that only the central organoid is represented. Also, in some embodiments, the modified image with the removed noise may be saved to a new folder. Each image in the original folder may be processed and saved in a comparable way.

In some embodiments, the area and intensity calculation(s) function may utilize pixel-based methods to calculate six distinct types of data, for example, organoid area, total image area, percentage of the image covered by the organoid, total intensity of the organoid, total intensity of organoid-by-organoid area, and total intensity of organoid by total image area. The area and intensity calculation(s) function may be iterated over the number of images in the original folder and used to create a spreadsheet with a total of six columns per image. For each image, the function area and intensity calculation(s) may standardize the image based on user input and then applied an Otsu thresholding algorithm with OpenCV. The Otsu thresholding algorithm may automatically calculate the standardized threshold value based on the given image to find the contour of the organoid. The area and intensity calculation(s) function may count the total number of pixels inside that contour and determine the values for the six types of data. The formulas for the percentage of organoid coverage, the total intensity of organoid-by-organoid area, and the total intensity of organoid by total image area are shown below:

$$Percentage of Organoid Coverage = \frac{Total Area of Organoid}{Total Area of Image} \\ Total Intensity of Organoid by Organoid Area = \frac{Total Intensity of Organoid}{Pixel Area of Organoid} \\ Total Intensity of Organoid by Total Image Area = \frac{Total Intensity of Organoid}{Total Area of Image}$$

In some embodiments, the fractal analysis function may be based on open-source code. The fractal analysis function may process a folder of images and output the fractal dimensions in a spreadsheet. The fractal analysis function may work by thresholding the image to binarize the image while maintaining fine detail. For example, the algorithm may split the pixel into rectangular bins, for example, to find the number of bins that have at least one bright pixel, according to the equation that follows. This process may be repeated with varying bin scales, where the scale of the bins refers to the fineness of the image subdivisions. The scale of the bins (which may be inversely proportional to the bin size) s and the number of bright bins n were transformed logarithmically. The function may compute the slope of the n vs s line of best fit to find the fractal value for the image. In addition to writing the fractal value to a spreadsheet, the fractal dimension (white-pixelated) image was also written into the folder.

Fractal Dimension(FD)=slope(n,s),scale of bins(s),and number of bright bins(n)

In some embodiment, the feature importance function may be performed via a lasso-regularized linear regression model, for example, that may be trained on the provided data. Feature importance values may be based upon permutation importance values calculated using, for example, Scikit-Learn.

The feature importance function may utilize input data in the form of a CSV file. The CSV file may represent the treatments may be applied to a rectangular plate with 48 specimens, organized in 6 rows and 8 columns. The input CSV's dimensions may be organized, for example in the following format: each row of the CSV represented one column (and thus, one set of treatments) in the organoid plates. Each column of the CSV may represent one drug treatment. The values in each box (row, column) (1) may reflect whether the corresponding treatment (column in the CSV) was applied to a corresponding plate column (row in the CSV) and (2) can reflect the quantity or volume of organoid differentiation factors.

The feature importance function may output the relative importance of each treatment, with higher numbers representing a larger significance of the treatment. The output may be provided in various formats, for example, a PNG file providing a graphical ranked view of the importance of each treatment and/or a CSV file providing the specific feature importance values of each treatment.

### EXAMPLES

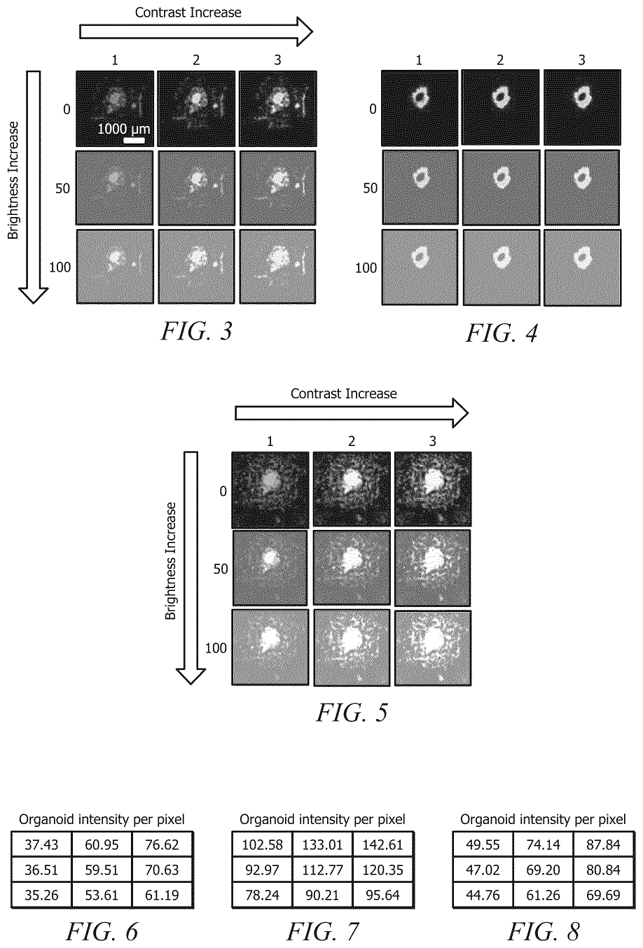

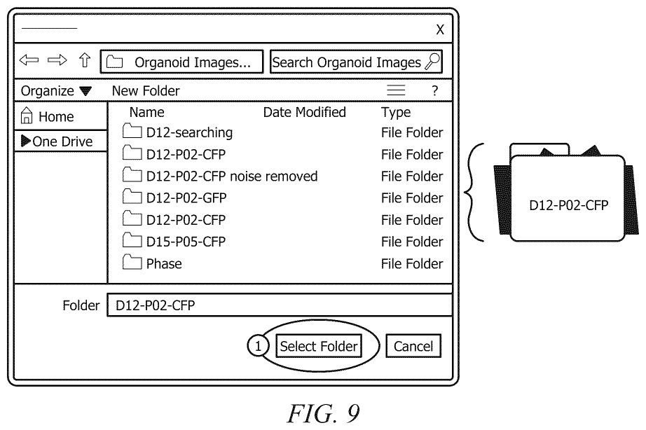

Referring to FIGS. 3, 4, and 5, the results the brightness and contrast functions, as disclosed herein, performed on three channels (blue-CFP, green-GPF, and red/orange-mOr) on the scales of 0-100 for brightness and 1-3 for contrast are shown. Also, referring to FIGS. 6, 7, and 8, the corresponding organoid intensities per pixel were measured and documented, following the adjustment of contrast and brightness. Referring to FIG. 9, the Organalysis platform can process images in bulk with the same scale of brightness and contrast for further quantified analysis. FIG. 9 demonstrates batch processing, shown for brightness/contrast function, but applicable for all functions in the Organalysis platform. In FIG. 9, the “Select folder” button in brightness/contrast function allows the user to choose a folder, or batch, of image, the “Process” button and Progress Bar in Organalysis, representing bulk iteration, and the newly created folder, which contains the bulk processed images are illustrated.

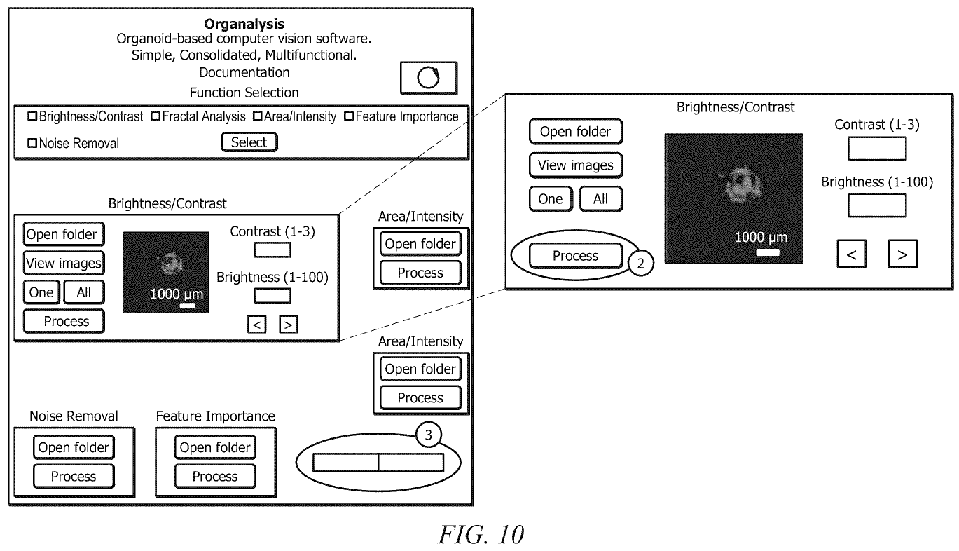

In the demonstration of the Organalysis platform, most of the organoid images, specifically those characterized by the CFP channel, contained errors that resulted from random objects floating in the culture medium such as air bubbles and small fibers. These images were subjected to the disclosed noise removal function, which employed a machine-identified contour that recognized the hPSC-derived cardiac organoids and subsequently removed the unnecessary background noise. Referring to FIGS. 10, 11, and 12, the results of the noise removal are shown. More examples can be found in FIG. 15, with respect to the CFP images. As shown, the original images contain noise around the organoids. The contoured images show the process of how the noise removal algorithm identify the organoid and removes the extraneous information that is not part of the region of interest.

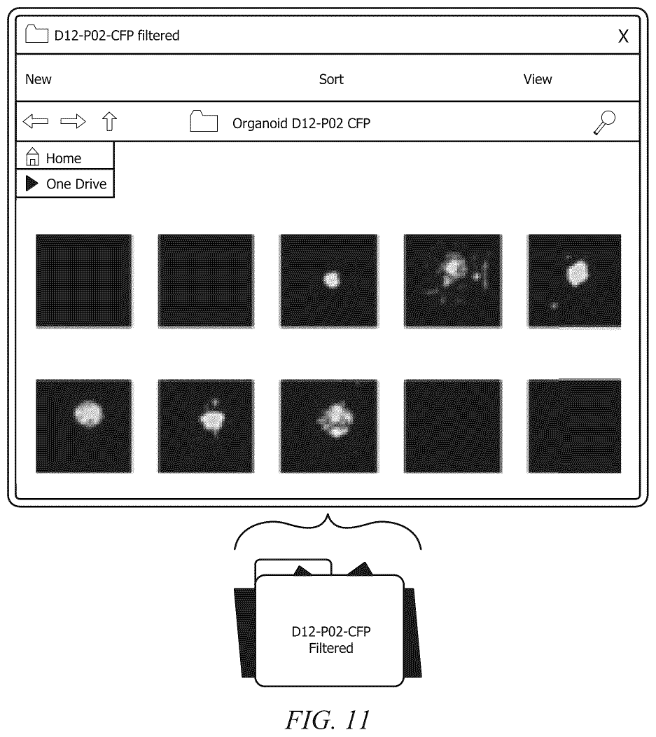

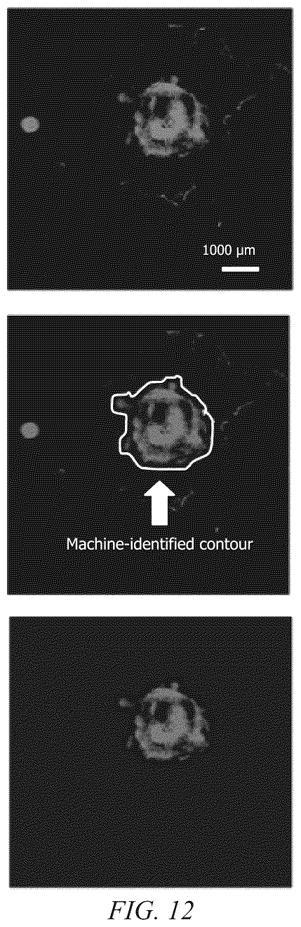

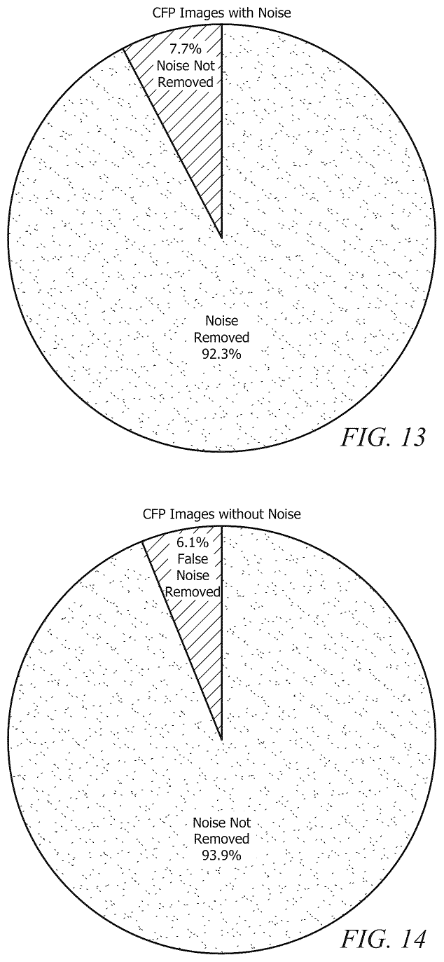

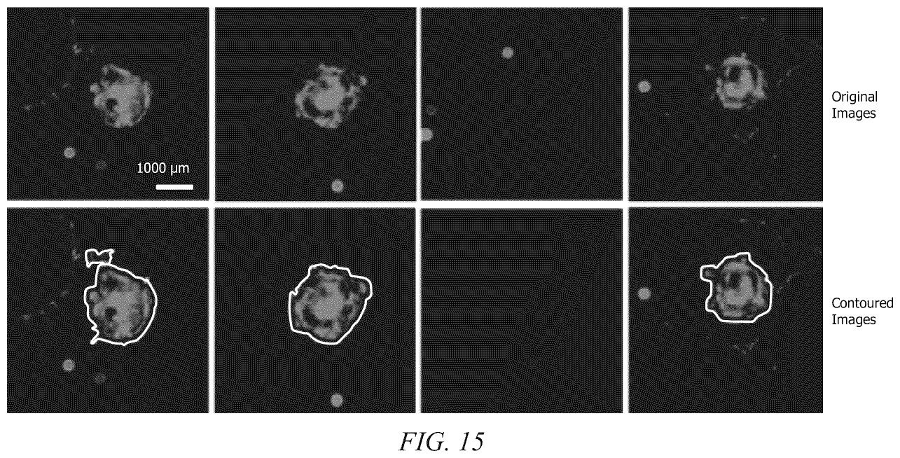

On CFP images that had noise, the Organalysis platform removed that noise almost 92% of the time, as demonstrated by FIG. 13. On CFP images that did not have noise, the Organlysis application did not detect any noise around 94% of the time, as demonstrated by FIG. 14. In FIG. 10, the selected image converted to a grayscale image through thresholding. In FIG. 11, the image runs through a contour-detection algorithm to identify the edges of the organoid. In FIG. 12, every pixel outside the contour set to black (0, 0, 0). In FIG. 13, accuracy of the noise removal technique on CFP images with noise is shown. In FIG. 14, accuracy of the noise removal technique on CFP images without noise displayed. N=46 images preprocessed is shown.

### Area and Intensity Calculations

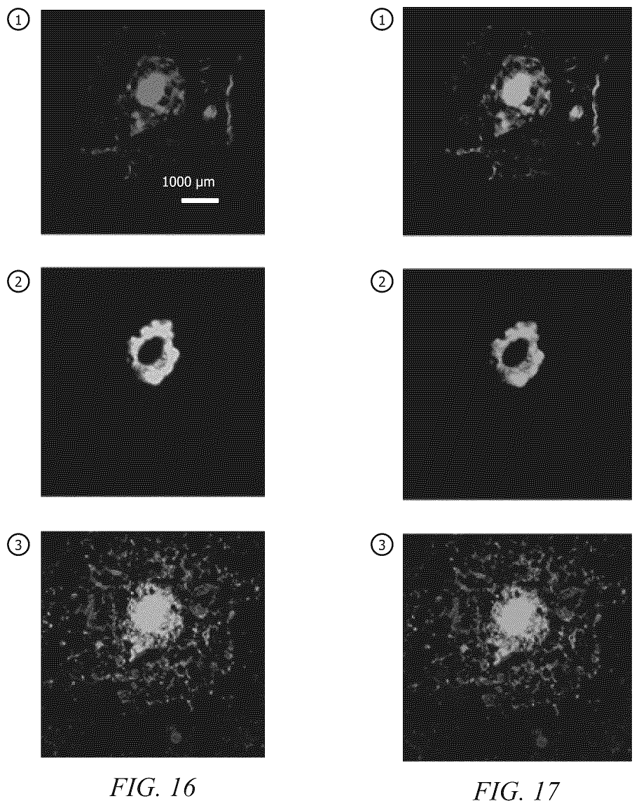

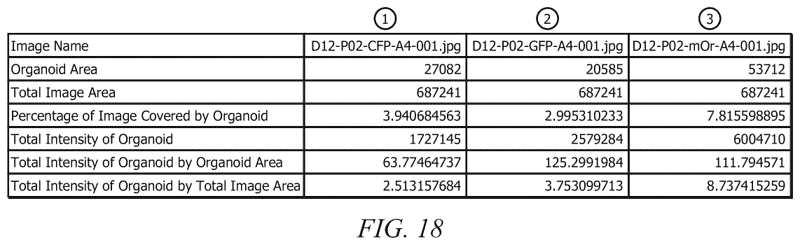

Also, in the demonstration of the Organalysis platform, the area/intensity function calculated six different values (for example, organoid area, total image area, percentage of the image covered by organoid, total intensity of organoid, total intensity of organoid-by-organoid area, and total intensity of organoid by total image area) for each image that was processed. Each image was measured and compared between ImageJ and Organalysis. This Organalysis platform calculated the area/intensity values by employing the Otsu thresholding algorithm, showing a precise method for calculation in this context. The same algorithm was also used on ImageJ. As shown in FIG. 16, the “total intensity of organoid-by-organoid area” values for the images may be obtained by splitting the dataset into the green channel, red channel, and blue channel sets. Also, each channel may be subjected to a grayscale filter, as shown in FIG. 17, and then the algorithm may be performed to output a spreadsheet with the data, as shown in FIG. 18. The function of the area and intensity measurement functions are shown in FIGS. 16 and 17. Generally, the function iterates through all images in the folder, thresholding the images to grayscale. The method takes measurements by going left-to-right and top-to-bottom, counting pixel-by-pixel. FIG. 18 shows the function-performed calculations saved into a spreadsheet with information that can be used for comparison and analysis.

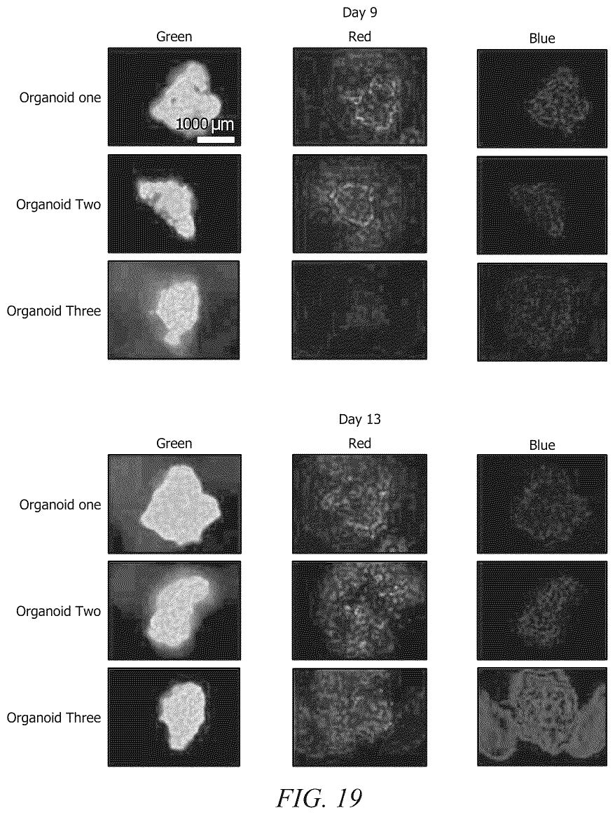

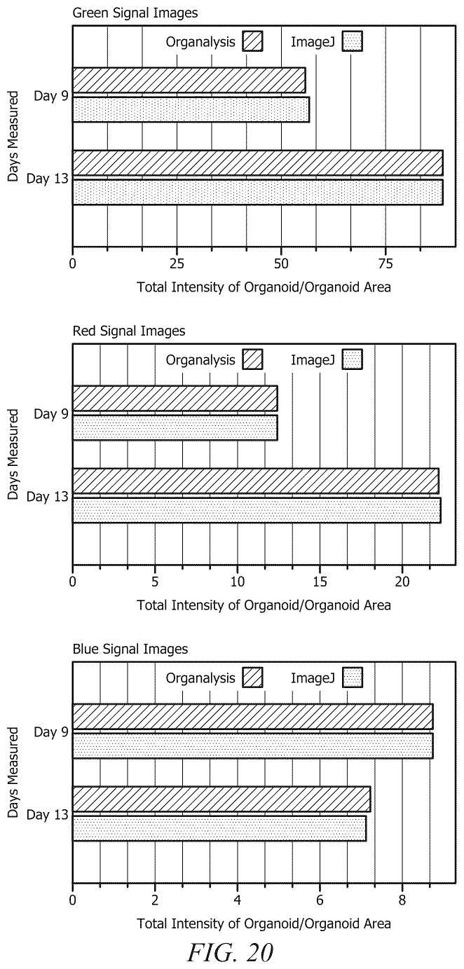

Additionally, more hPSC-derived cardiac organoids were also measured at days 9 and 13, the results of which are demonstrated in FIG. 19. The percentage errors of the measurements via the Organalysis platform in the three channels are in the range of 0.03% to 1.3% as shown in FIG. 20; the ImageJ measurement was taken as the exact value.

### Fractal Analysis

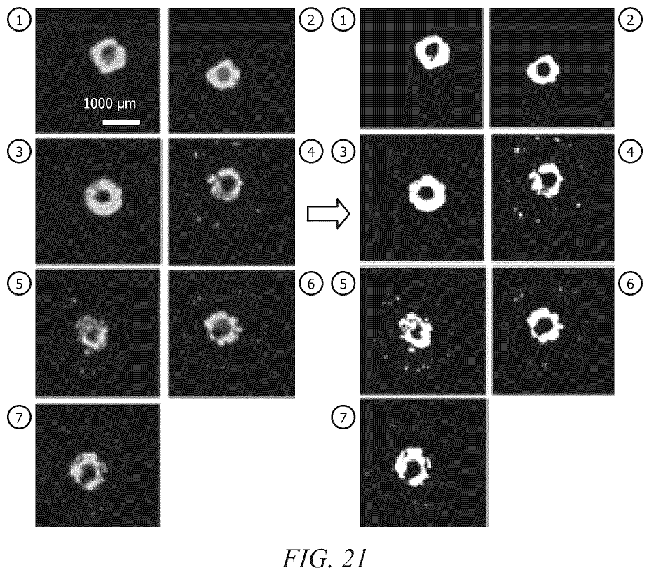

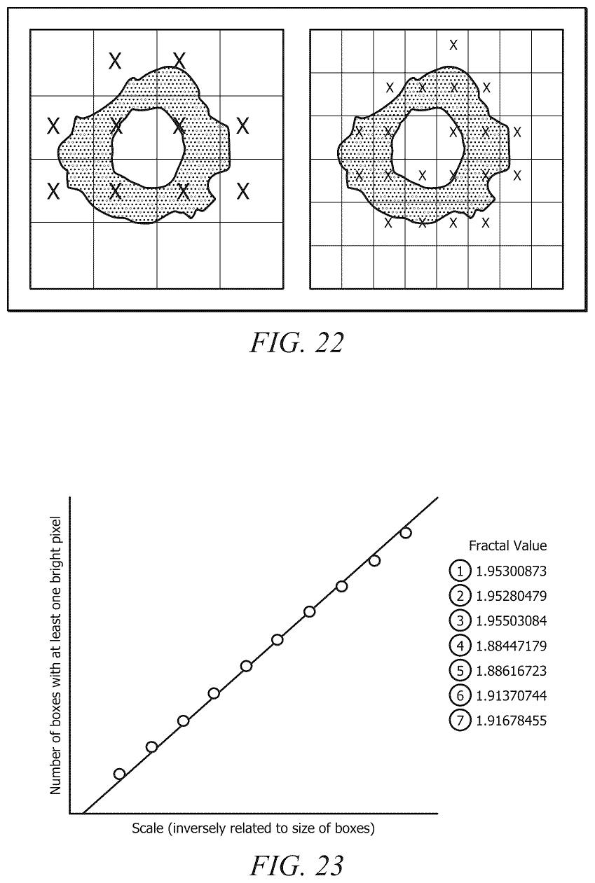

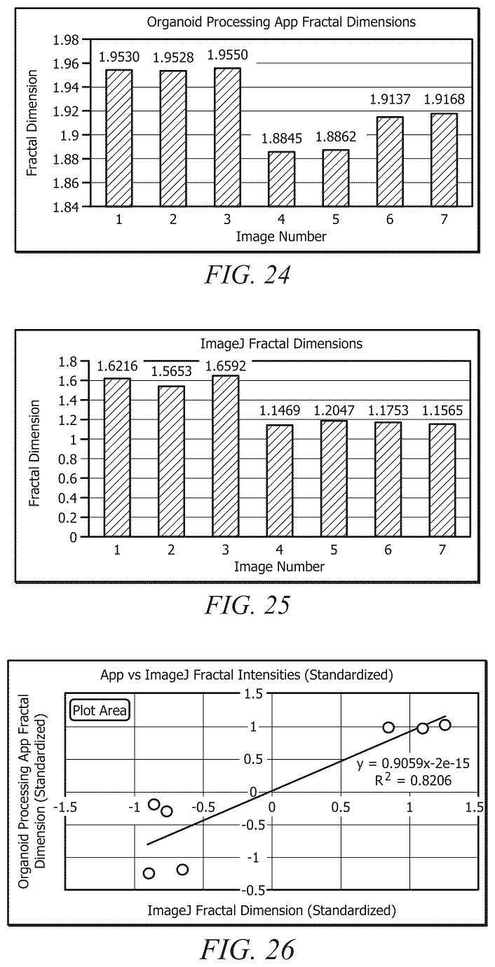

The fractal analysis of hPSC-derived cardiac organoids functionality is shown with respect to FIGS. 21, 22, 23, 24, 25, and 26. FIG. 21 shows GFP images loaded from the folder and converted into binarized images. FIG. 22 shows transformed images split up into boxes with 10 logarithmically distributed box sizes. Each box is defined by the number of bright pixels it contains. FIG. 23 shows a linear regression identifying the slope between the number of boxes with at least one bright pixel and the scale of the boxes. Both variables transformed logarithmically. FIG. 24 shows a bar graph representing FD measured by Organalysis. FIG. 25 shows a bar graph representing FD measured by ImageJ plugin FracLac using the same set of images. FIG. 26 shows a correlation of FD measurements by Organalysis and ImageJ.

Generally, the fractal analysis proceeded via classical procedures. For example, first, the algorithm binarized the RGB images, as shown in FIG. 21. Then, logarithmically distributed boxes were created on the image as shown in FIG. 22, and linear regression was performed on the boxes with at least one non-black pixel as shown in FIG. 23. FIG. 24 indicates the fractal dimension (FD) values of organoid images automatically measured by the Organalysis platform, while FIG. 25 shows the FDs of the same organoid images manually measured by the ImageJ plugin FracLac. A linear regression chart comparing ImageJ values to organoid application values was created and is shown in FIG. 26, indicating that the R² value was equal to around 0.8206. This means that the values from ImageJ and Organalysis, respectively, were well correlated and followed a similar best-fit line. The individual fractal values output by ImageJ were slightly higher than those output by the organoid application. This discrepancy can be attributed to a difference in performing the methods to obtain values, for example, a minute variation in the logarithmic threshold while converting to grayscale. Regardless, the efficiency of Organalysis platform offsets the contrast in fractal values.

### Feature Importance

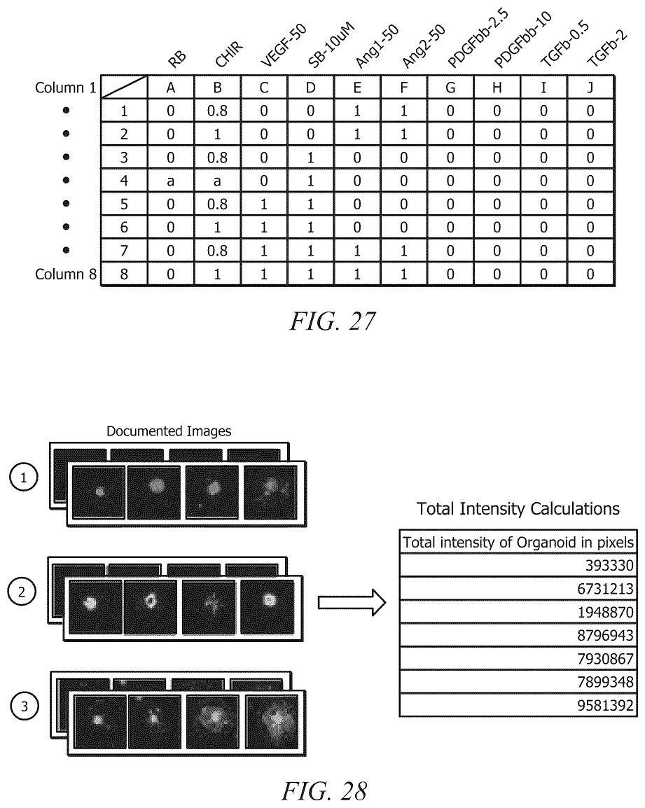

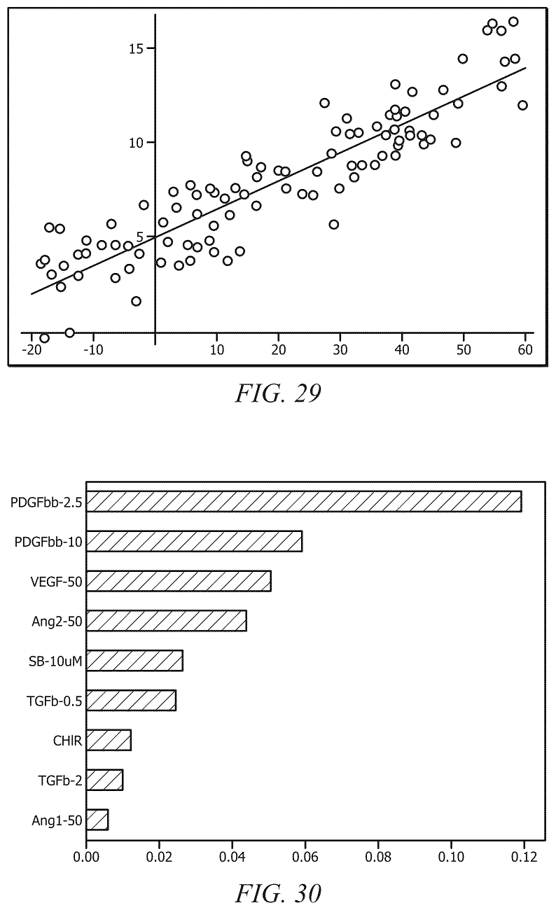

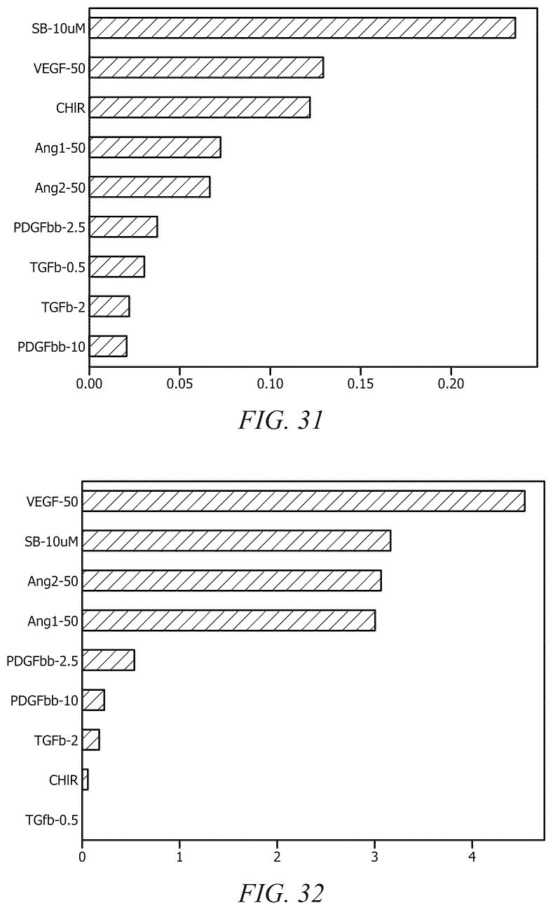

In the feature importance function, a feature spreadsheet was created, as shown in FIG. 27, of various differentiation factors of hPSC-derived cardiac organoids. Those differentiation factors include both small molecules and growth factors for deriving the vascularized cardiac organoid from hPSCs. Based on the intensity values for each image in FIG. 27 and the input spreadsheet, which contained the respective differentiation treatments and their combinations (1 for with and 0 for without), the Lasso-regularized linear regression, as shown in FIG. 29, machine-learning algorithm was trained to output a chart based on its prediction of the differentiation outcomes. Based on the outputted graphs for each color that differentiate cell types, the feature importance function primarily identified the PDGFbb-2.5 nM, PDGFbb-10 nM, VEGF-50 nM, Ang2-50 nM, and SB-10 μM as the top five determinators for the formation of CFP-TAGLN-SMC in the hPSC-derived cardiac organoids, as shown in FIG. 30, while the SB-10 mM, VEGF-50 nM, CHIR, and Ang1&2-50nM were more relevant to the GFP-TNNT2-CMs differentiation, as shown in FIG. 31. Similarly, these smooth muscle cell-relevant differentiation factors were shared mostly with the endothelial cell-relevant differentiation factors indicated by the mOr-VE-Cadherin reporter, as shown in FIG. 32.

Disclosed herein is a GUI-based multifunctional, consolidated, and simplified organoid image preprocessing and analysis application called the “Organalysis platform.” This multifunctional application enables both preprocessing and analysis of fluorescent images from the hPSC-derived cardiac organoids with multiple functions by iterating through all images in a folder at once, simplifying the user interface and reducing the number of clicks needed to process images. Currently, there is no automated software that comprises such functions, targeted at handling multiple organoid images at once. Although similar functions have been developed such as structural imaging, noise reduction, and adjustment thresholding, the novel Organalysis platform disclosed herein incorporates new algorithms with more efficacy into a consolidated environment, enabling the application of hPSC-derived cardiac organoids with ease and accuracy in the functions of brightness & contrast, noise removal, area and intensity measurement, fractal analysis, and feature importance.

Adjusting specific filters within an image allow for overall enhancements. For example, a darker image with lower contrast would be hard to analyze because it would have features that are inadequately represented. On the other hand, a brighter image with higher contrast would be much easier to examine because it would have features that are intensified. The Organalysis platform, as disclosed herein, allows for multiple images to be iterated through at once. Because of the simplicity of the Organalysis platform, processing the images for filters before analyzing them can prove to be invaluable in saving time and creating better data.

Additionally, when documenting images under a microscope, inconsistencies such as bubbles in the well plate may present themselves in the image. To target this issue and remove this noise, the noise removal functionality as disclosed herein proved significantly useful in increasing the accuracy of specific measurements. Although noise can be removed image by image, it is a time-consuming task. Therefore, through automation, removing noise can become much faster and easier. In this application, the automatic noise removal function enhances the quality of the image by employing a contour detection algorithm. The Organalysis platform processes all the images in a folder at once and requires minimal clicks. This noise removal functionality is highly effective because the images it updates can be used to receive better results from other functions. Images can be preprocessed through this functionality for further machine-learning analysis and other automated techniques so that they can have a more accurate measurement of organoid images.

The brightness and contrast-adjusted and noise-removed images were further measured by the fluorescence area and intensity to quantify the cardiac organoid cell groups. The area and intensity measurement functionality of the Organalysis platform processes all the images in one folder and finds the corresponding values based on pixel measurements. This functionality is especially useful in characterizing the growth of organoids over a certain period. By analyzing the spreadsheet that is output by this function, it can become easier to compare cardiac organoids side-by-side for organoid differentiation based on various conditions. The spreadsheet that this function outputs can be employed in numerous analysis methods concerning the development of the cardiac organoid. By understanding the numerical significance of each value, it can become easier to identify the optimal differentiation factors for the hPSC-derived cardiac organoid formation. The area and intensity measurement functionality provides a solid and high-throughput method to iterate through all the images in a folder with minimalized clicks, higher accuracy, and greater efficiency.

Moreover, the complexity of the hPSC-derived cardiac organoid formation can be analyzed by fractal analysis. For example, the network of cardiomyocytes in the hPSC-derived cardiac organoids can be analyzed by fractal analysis with FD to indicate the process of cardiac organoid differentiation and development. This complex cardiac structure of hPSC-cardiomyocytes could be correlated to certain growth factors applied to the hPSC differentiation. Specifically, the FDs can be calculated at once based on the various scales of microscopic organoid images. More importantly, the Organalysis platform shows a highly correlated trend of FD measured by the ImageJ Macro. Therefore, if there are more extensive complex structures inside an organoid, the FD will increase. By combining these tools, differentiation factors affecting the development of complex organoid formation can be further explored.

Finally, the correlation between various differentiation factors and hPSC-derived cardiac organoid development was analyzed by the feature importance function, which revealed the features of a model that have the most impact on a target. In the Organalysis platform, the features were the differentiation factors applied to differentiate the hPSC-derived vascularized cardiac organoids with targeted cardiovascular cell types. The feature importance function ranked the differentiation factors of each cardiovascular cell type (cardiomyocytes, smooth muscle cells, and endothelial cells) in the hPSC-derived vascularized cardiac organoids, which supports the differentiation protocol design and outcomes. Moreover, the default plate, row, and column dimensions can be adjusted by modifying some variables in the code; due to the usage of this setup in the lab and the tedium of repeatedly entering information, it can be more efficient for users to have the defaults set as they are with this feature importance function.

Collectively, the Organalysis platform provides an interface for organoid researchers to process bulk image data more efficiently and intuitively. This application provides the preprocessing functions of brightness/contrast adjustment and noise removal, area/intensity computation, fractal analysis for organoid complexity, and feature importance for comparison and identification of major influences on organoid differentiation. The functions in the the Organalysis platform correlate with measurements taken with established methods and provide a more accurate measurement than established methods. Due to its flexibility, the Organalysis platform can work with many more variations of image type and resolution.

In summary, the Organalysis platform scrutinizes developing cardiac organoid images for in-depth quantification results and graphical trend analysis. It also improves the quality of organoid images through processing filters in the application. These efficient methods prove invaluable to further applications of hPSC-derived organoids in disease modeling and regenerative medicine. The Organalysis platform can be employed in image-based organoid research to rapidly amplify inconsistent data and determine essential mechanisms in organoids.

Having described various systems, processes, and methods, certain aspects can include, but are not limited to:

In a first aspect, a system for analyzing a plurality of organoids comprises: an imaging device configured to collect an image for an organoid of the plurality of organoid; and a non-transitory medium comprising instructions causing a computer to implement an organoid analysis platform, wherein the organoid analysis platform is configured to perform an organoid analysis method.

A second aspect can include the system of the first aspect, wherein the image collected by the imaging device is a microscopic image.

A third aspect can include the system of the first or second aspect, wherein the image collected by the imaging device is a fluorescent image.

A fourth aspect can include the system of any one of the first to third aspects, wherein the organoid analysis method includes preprocessing the image of the organoid.

A fifth aspect can include the system of the fourth aspect, wherein preprocessing the image for the organoid comprises adjusting the brightness or contrast of the image.

A sixth aspect can include the system of the fourth or fifth aspect, wherein preprocessing the image for the organoid comprises removing noise from the image.

A seventh aspect can include the system of any one of the first to sixth aspects, wherein the organoid analysis method includes analyzing the image for the organoid.

An eighth aspect can include the system of the seventh aspect, wherein analyzing the image for the organoid comprises calculating the area of the organoid in the image.

A ninth aspect can include the system of any the seventh or eighth aspect, wherein analyzing the image of the organoid comprises determining the intensity of an organoid-by-organoid area.

A tenth aspect can include the system of any one of the first to ninth aspects, wherein the organoid analysis method includes performing a fractal analysis of the image.

An eleventh aspect can include the system of any one of the first to tenth aspects, wherein analyzing the image for the organoid comprises determining a plurality of differentiation factors associated with the organoid.

A twelfth aspect can include the system of the eleventh aspect, wherein analyzing the image for the organoid comprises determining a feature importance value for each of a plurality of the differentiation factors.

In a thirteenth aspect, a method for analyzing a plurality of organoids comprises obtaining an image for an organoid of the plurality of organoid; and performing, via an organoid analysis platform embodied in instructions stored on a non-transitory medium, an organoid analysis method.

A fourteenth aspect can include the method of the thirteenth aspect, wherein the image is a microscopic image.

A fifteenth aspect can include the method of the thirteenth or fourteenth aspect, wherein the image is a fluorescent image.

A sixteenth aspect can include the method of any one of the thirteenth to fifteenth aspects, wherein performing the organoid analysis method includes preprocessing the image of the organoid.

A seventeenth aspect can include the method of the sixteenth aspect, wherein preprocessing the image for the organoid comprises adjusting the brightness or contrast of the image.

An eighteenth aspect can include the method of the sixteenth or seventeenth aspect, wherein preprocessing the image for the organoid comprises removing noise from the image.

A nineteenth aspect can include the method of any one of the thirteenth to eighteenth aspects, wherein performing the organoid analysis method includes analyzing the image for the organoid.

A twentieth aspect can include the method of the nineteenth aspect, wherein analyzing the image for the organoid comprises calculating the area of the organoid in the image.

A twenty first aspect can include the method of the nineteenth or twentieth aspect, wherein analyzing the image of the organoid comprises determining the intensity of an organoid-by-organoid area.

A twenty second aspect can include the method of any one of the thirteenth to twenty first aspects, wherein performing the organoid analysis method includes performing a fractal analysis of the image.

A twenty third aspect can include the method of any one of the thirteenth to twenty second aspects, wherein analyzing the image for the organoid comprises determining a plurality of differentiation factors associated with the organoid.

A twenty fourth aspect can include the method of the twenty third aspect, wherein analyzing the image for the organoid comprises determining a feature importance value for each of a plurality of the differentiation factors.

While aspects of the presently disclosed subject matter have been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the presently disclosed subject matter. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A system for analyzing a plurality of organoids, the system comprising:
an imaging device configured to collect a plurality of images for an organoid of the plurality of organoids; and
a non-transitory medium comprising instructions causing a computer to implement an organoid analysis platform, wherein the organoid analysis platform is configured to:
determine a plurality of features from the plurality of images, wherein the plurality of features comprise a plurality of an organoid area, a total image area, a percentage of the image covered by organoid, a total intensity of organoid, a total intensity of organoid-by-organoid area, or a total intensity of organoid by total image area;
determine, using the plurality of features from the plurality of images, one or more differentiation factors between the plurality of images, wherein the one or more differentiation factors comprise small molecule factors and growth factors.

2. The system of claim 1, wherein the image collected by the imaging device is a microscopic image or a fluorescent image.

3. The system of claim 1, wherein the organoid analysis method includes preprocessing the image of the organoid.

4. The system of claim 3, wherein preprocessing the image for the organoid comprises adjusting the brightness or contrast of the image.

5. The system of claim 3, wherein preprocessing the image for the organoid comprises removing noise from the image.

6. The system of claim 1, wherein the organoid analysis method includes analyzing the image for the organoid.

7. The system of claim 6, wherein analyzing the image for the organoid comprises calculating the area of the organoid in the image.

8. The system of claim 6, wherein analyzing the image of the organoid comprises determining the intensity of an organoid-by-organoid area.

9. The system of claim 1, wherein the organoid analysis method includes performing a fractal analysis of the image.

10. The system of claim 9, wherein analyzing the image for the organoid comprises determining a feature importance value for each of a plurality of the differentiation factors.

11. A method for analyzing a plurality of organoids, the method comprising:
obtaining a plurality of images for an organoid of the plurality of organoids; and
determining a plurality of features from the plurality of images, wherein the plurality of features comprise a plurality of an organoid area, a total image area, a percentage of the image covered by organoid, a total intensity of organoid, a total intensity of organoid-by-organoid area, or a total intensity of organoid by total image area;
determining, using the plurality of features for the plurality of images, one or more differentiation factors between the plurality of images, wherein the one or more differentiation factors comprise small molecule factors and growth factors.

12. The method of claim 11, wherein the image is a microscopic image or a fluorescent image.

13. The method of claim 11, wherein performing the organoid analysis method includes preprocessing the image of the organoid.

14. The method of claim 13, wherein preprocessing the image for the organoid comprises adjusting the brightness or contrast of the image.

15. The method of claim 13, wherein preprocessing the image for the organoid comprises removing noise from the image.

16. The method of claim 11, wherein performing the organoid analysis method includes analyzing the image for the organoid.

17. The method of claim 16, wherein analyzing the image for the organoid comprises calculating the area of the organoid in the image.

18. The method of claim 16, wherein analyzing the image of the organoid comprises determining the intensity of an organoid-by-organoid area.

19. The method of claim 11, wherein performing the organoid analysis method includes performing a fractal analysis of the image.

20. The method of claim 11, wherein analyzing the image for the organoid comprises determining a feature importance value for each of a plurality of the differentiation factors.
